(19) United States
(12) Patent Application Publication
(10) Pub. No.: US 2011/0149750 A1
(43) Pub. Date: Jun. 23, 2011

(54) SUBSCRIBER FALLBACK/MIGRATION MECHANISMS IN IMS GEOGRAPHIC REDUNDANT NETWORKS

(75) Inventors: Anish Sharma, Ajmer (IN); Nagesh Kumar Bollapalli, Bangalore (IN); Siddharth Toshniwal, Bangalore (IN)

(73) Assignee: Sonus Networks, Inc., Westford, MA (US)

(21) Appl. No.: 12/642,424

(22) Filed: Dec. 18, 2009

(51) Int. Cl. H04J 1/16; H04W 36/00

(52) U.S. Cl. 370/252; 370/331

(57) ABSTRACT

A system and method for maintaining service availability for an Internet Protocol Multimedia Subsystem (IMS) network is provided. A primary network receives a request from one or more subscribers of the primary network to place a call. The primary network registers the one or more subscribers. The primary network assigns an identifier to data of the one or more registered subscribers for the registration. The identifier associates the one or more subscribers with the primary network upon migration of the one or more subscribers from the primary network to the secondary network. The secondary network monitors the primary network to detect an event on the primary network. The secondary network migrates the one or more subscribers from the secondary network to the primary network based on the identifier and after initiation of the migration in response to the occurrence of the event on the primary network.

### FIELD OF THE INVENTION

The present invention pertains to disaster recovery in Internet Protocol Multimedia Subsystems (IMS) networks, and in particular, to migration of subscribers of IMS networks after disaster recovery.

### BACKGROUND OF THE INVENTION

IMS is an architectural framework for delivering Internet Protocol (IP) multimedia services (e.g., mobile phones and personal digital assistants). IMS is defined by a Third Generation Partnership Project (3GPP) as a mobile network infrastructure that enables data, speech, and mobile network technology to converge over an IP-based infrastructure. IMS integrates existing traditional telecommunications technology (e.g., a Public Switched Telephony Network (PSTN)) and Internet technology, allowing network operators to offer a standardized, reusable platform that can be used to provide services for both mobile networks and landline networks at the same time, providing a unique mixtures of services with transparency to the end-user.

The main function of IMS is to set up media communication sessions between users, and between users and applications. IMS uses a session initiation protocol (SIP) and/or Radius protocol and/or Diameter protocol for initiating, modifying, and terminating an interactive user session that involves multimedia elements, such as call sessions, voicemail, call forwarding, instant messaging and online games. IMS provides the service creator with the ability to combine services in the same session and dynamically modify sessions “on the fly” (e.g., adding a video component to an existing voice session). As a result, new and innovative user-to-user and multi-user services become available, such as enhanced voice services, video telephony, chat, push-to-talk, and multimedia conferencing, all of which are based on the concept of a multimedia session.

An IMS network may be controlled by an operator, which is typically a business entity (e.g., a telephone company). The set of IMS entities within a particular operator's control may be referred to as an operator's network. The operator may control the operator's network from a network operator's console (NOC). Typically, all of an operator's subscribers are assigned to the operator's network. A subset of subscribers in an operator's network may be referred to as a point of presence (POP).

As used herein, the term “IMS network element” (NE) refers to a logical grouping of entities that perform a specific assigned IMS function or group of functions within an IMS network. IMS functions include the call session control function (CSCF), the home subscriber server (HSS) function, charging collector function (CCF) or charging data function (CDF), and application server (AS) functions.

The CSCF is used to process SIP/Radius/Diameter signaling packets in IMS networks. The CSCF aids in the setup and management of sessions and forwards messages between IMS networks. There are three distinct CSCF functions: proxy CSCF (P-CSCF), interrogation CSCF (I-CSCF), and serving CSCF (S-CSCF). The P-CSCF is the first point of contact for a subscriber connecting to the IMS network; it is the gateway into the IMS network. The P-CSCF implements compression and security. A P-CSCF can forward subscriber originated registration requests to an I-CSCF. The I-CSCF provides a registration location function (RLF), which maps and routes requests from a subscriber to a specific S-CSCF by contacting an HSS. The I-CSCF also provides a network interconnect function (NIF). The NIF routes requests to other interconnecting networks via the I-CSCFs of the specific interconnecting network. The S-CSCF is the core of the network. The S-CSCF maintains the subscriber's registration status and service profile. The S-CSCF provides services for the users, such as setting up media communication sessions between users and applications.

The HSS holds key subscriber information and enables users (or servers) to find and communicate with other end users. The AAA authenticates the user, gives access only to valid users, grants the user authority to use certain functions or features available on the IMS network, and tracks user activity for accounting and billing purposes.

Additional IMS functions include, for example, such as caller ID, call waiting, call holding, push to talk, call forwarding, call transfer, call blocking, malicious caller identification, lawful interception, announcement services, conference call services, voicemail, text to speech and speech to text, location-based services, messaging services and instant messaging, presence information, enumeration (ENUM), and 2-G gateway services. The additional IMS function can be provided by application servers.

In the Public Switched Telephone Network (PSTN) calls are routed over a circuit-switched telephone network. When calls are made, specific circuits are used to route the calls. The specific circuits are referred to as trunks. A group of trunks that connect to the same target switch are known as trunk groups. Trunk group parameters establish the connections within or between switching system and are defined by a standard known as RFC 4904. As part of the integration between traditional telecommunications technology (e.g., a Public Switched Telephony Network (PSTN)) and internet technology, trunks and trunk groups for internet protocol networks are extensions of PSTN trunks and trunk groups. These extended trunks and trunk groups are known as internet protocol trunks (IP trunks) and internet protocol trunk groups (IP trunk groups).

### SUMMARY OF THE INVENTION

The invention, in one aspect, features systems and methods for providing a mechanism in IMS networks to identify subscribers that were migrated to a remote site due to a failure of a primary site and migrating the identified subscribers back to the primary site when it is restored.

The invention, in one aspect, features a method of maintaining service availability for an Internet Protocol Multimedia Subsystem (IMS) network. The method also involves registering, by a primary network, one or more subscribers. The method also involves receiving a request, by the primary network, from the one or more subscribers of the primary network, to initiate a service. The method also involves assigning, by the primary network, an identifier to data of the one or more registered subscribers for the registration wherein the identifier associates the one or more subscribers with the primary network upon migration of the one or more subscribers from the primary network to the secondary network. The method also involves, monitoring, by a secondary network (e.g., an edge network or secondary IMS core network), the primary network to detect an event on the primary network. The method also involves migrating the one or more subscribers from the secondary network to the primary network based on the identifier and after initiation of the migration in response to the occurrence of the event on the primary network.

In some embodiments, migrating the one or more subscribers from the secondary network to the primary network is further in response to an operator command. In some embodiments, migrating in response to the operator command includes specifying a geographic location of the primary network to which the one or more subscribers migrate, specifying a time for the one or more subscribers to begin migrating and specifying a rate at which the one or more subscribers are preferred to be migrated.

In some embodiments, migrating in response to the operator command includes specifying one or more subset groups of the one or more subscribers and migrating the one or more subset groups based on an order of priority.

In some embodiments, the method also involves visually displaying a migration status showing the migration state of the migration of the one or more subscribers between the primary network and the secondary network to an operator. In some embodiments, the identifier is based on the one or more subscribers' type of service, a geographic location of the one or more subscribers, or any combination thereof. In some embodiments, the one or more subscribers is a plurality of subscribers and migrating the plurality of subscribers from the secondary network to the primary network is further based on an order of priority among each of the plurality of subscribers. In some embodiments, the order of priority is based on at least one of traffic level on the secondary network, the one or more subscribers type of service, or an operator command.

In some embodiments, assigning the identifier includes adding the identifier to one or more IP trunks associated with the one or more subscribers. In some embodiments, assigning the identifier includes inserting at least one of a group parameter or a context parameter in a header of each of the one or more IP trunks. In some embodiments, assigning the identifier includes augmenting a path header associated with the primary network. In some embodiments, the path header includes a SIP path header. In some embodiments, augmenting the path header includes inserting a parameter into the path header.

In some embodiments, monitoring the primary network includes sending traffic signals to the primary network from the secondary network at a fixed time interval and detecting a response signal from the primary network. In some embodiments, detecting a response signal includes transmitting the response signal to the secondary network.

In some embodiments, the primary network includes a first interrogating network and a first session handling server. In some embodiments, receiving the request includes transmitting the request, by an entry point network associated with the primary network, to the first interrogating network associated with the primary network, obtaining subscriber data, by the first interrogating network, from a subscriber server based on the request and the one or more subscribers, and routing, by the first interrogating network, the request to the first session handling server, wherein the first session handling server initiates sessions for each of the one or more subscribers and handles services for each of the one or more subscribers.

In some embodiments, the secondary network includes a second interrogating network and a second session handling server. In some embodiments, the method also includes migrating the one or more subscribers from the primary network to the secondary network. In some embodiments, migrating the one or more subscribers includes transmitting the request and the subscriber data from the entry point network to the second interrogating network associated with the secondary network and routing, by the second interrogating network, the request to the second session handling sever, wherein the second session handling server handles sessions for each of the one or more subscribers and initiates services for each of the one or more subscribers.

In some embodiments, assigning the identifier includes inserting at least one of a context parameter or a group parameter in at least one header of one or more IP trunks associated with the one or more subscribers, wherein the context parameter indicates the entry point network that transmitted the request and the group parameter indicates the one or more IP trunks and the one or more subscribers type of service.

In some embodiments, assigning the identifier includes inserting a context parameter into a path header associated with the one or more subscribers, wherein the context parameter indicates the entry point network.

In some embodiments, migrating the one or more subscribers from the secondary network to the entry point network includes terminating the sessions and the services initiated by the second session handling server once the migration is complete.

The invention, in another aspect, features a computer program product for maintaining service availability on an Internet Protocol Multimedia Subsystem (IMS) network, tangibly embodied in a computer-readable storage medium, the computer program product containing instructions being operable to cause a data processing apparatus to register, by a primary network, one or more subscribers. The computer program product is operable to receive a request, by the primary network, from the one or more subscribers of the primary network, to initiate a service. The computer program product is operable to cause a data processing apparatus to assign, by the primary network, an identifier to data of the one or more registered subscribers for the registration. The computer program product is operable to cause a data processing apparatus to monitor, by a secondary network, the primary network to detect an event on the primary network and migrate the one or more subscribers from the secondary network to the primary network based on the identifier and after initiation of the migration in response to the occurrence of the event on the primary network.

The invention, in another aspect, features a system for maintaining service availability for an Internet Protocol Multimedia Subsystem (IMS) network. The system includes means for registering, by a primary network, one or more subscribers. The system also includes means for receiving a request, by the primary network, from the one or more subscribers of the primary network, to initiate a service. The system also includes means for and means for assigning, by the primary network, an identifier to data of the one or more registered subscribers for the registration. The system also includes means for monitoring, by a secondary network, the primary network to detect an event on the primary network and means for migrating the one or more subscribers from the secondary network to the primary network based on the identifier and after initiation of the migration in response to the occurrence of the event on the primary network.

The invention, in another aspect, features a method of maintaining service availability for an Internet Protocol Multimedia Subsystem (IMS) network. The method involves monitoring, by a secondary network, a primary network to detect an event on the primary network. The method also involves migrating one or more subscribers from the secondary network to the primary network based on an identifier assigned to the one or more subscribers and after initiation of the migration in response to the occurrence of the event on the primary network wherein the one or more subscribers were initially registered on the primary network and wherein the identifier assigned to the one or more subscribers associated the one or more subscribers with the primary network when initially migrated from the primary network to the secondary network.

Other aspects, examples, and advantages of the present invention, as well as the invention itself, will be more fully understood from the following description of various embodiments, when read together with the accompanying drawings.

### BRIEF DESCRIPTION OF THE DRAWINGS

The foregoing features of the invention will be more readily understood by reference to the following detailed description, taken with reference to the accompanying drawings, in which:

FIG. 1 is a diagram showing two IMS networks with a primary and secondary relationship, according to an illustrative embodiment of the invention.

FIG. 2 is a flow chart illustrating a method for disaster recovery in IMS networks, according to an illustrative embodiment of the invention.

FIG. 3 is a flow chart illustrating a method for determining a state of a primary IMS network, according to an illustrative embodiment of the invention.

FIG. 4A is a sequence diagram of migrating a subscriber from a primary IMS network to a secondary IMS network with SIP protocol and Diameter protocol messaging, according to an illustrative embodiment of the invention.

FIG. 4B is a sequence diagram of migrating the subscriber of FIG. 4A from the secondary IMS network to the primary IMS network with SIP protocol and Diameter protocol messaging.

### DETAILED DESCRIPTION OF ILLUSTRATIVE EMBODIMENTS

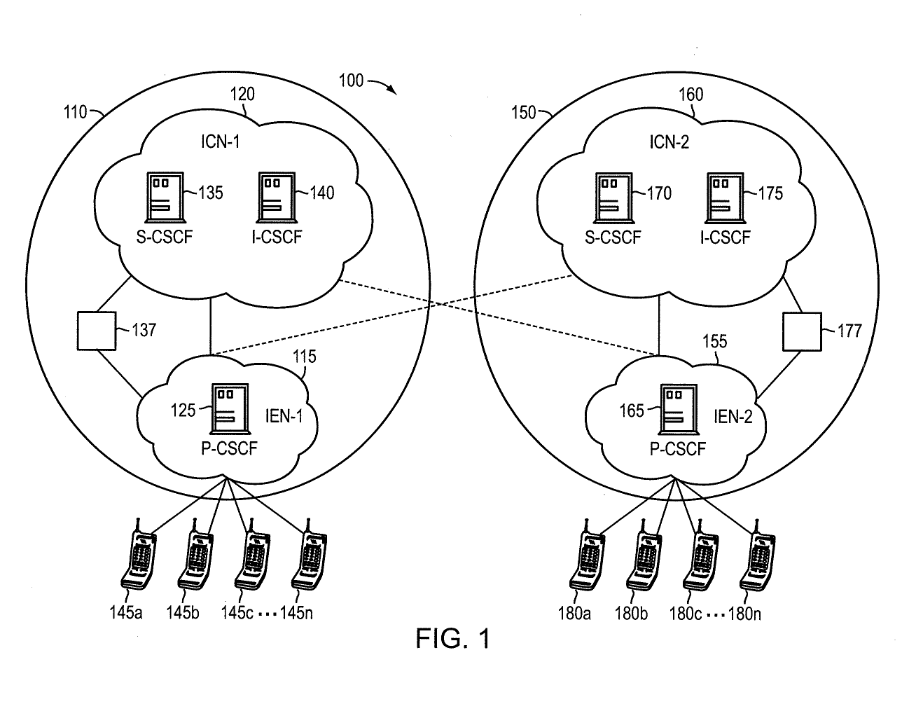

FIG. 1 is a diagram 100 showing two IMS networks with a primary and secondary relationship. A first IMS network 110 includes a first IMS Edge Network (IEN-1) 115, a first IMS Core Network (ICN-1) 120 and an operator 137. The IEN-1 115 includes a P-CSCF 125 and the ICN-1 120 includes a I-CSCF 140, and a S-CSCF 135. The IEN-1 115 receives service requests from one or more subscribers 145a, 145b, 145c, . . . , 145n (generally 145) of the first IMS network 110. The P-CSCF 125 registers the one or more subscribers to the first IMS network 110 and assigns an identifier to the one or more subscribers identifying the one or more subscribers as subscribers of the first IMS network 110. The P-CSCF 125 also performs various functions (as discussed above) for each service request, forwards the registration to the I-CSCF 140 of the ICN-1 120 and forward session setup requests to the S-CSCF 135 of ICN-1 120.

For each service request the I-CSCF 140 obtains data associated with the subscribers 145 from a HSS (not shown) and routes the service requests to the S-CSCF 135. The S-CSCF 135 also obtains data associated with the subscribers 145 from the HSS and routes the service requests to their final destination.

A second IMS network 150 includes a second IMS edge network (IEN-2) 155, a second IMS core network (ICN-2) 160 and an operator 177. The IEN-2 155 includes a P-CSCF 165 and the ICN-2 160 includes a I-CSCF 175, and a S-CSCF 170. The IEN-2 155 receives the service requests from one or more subscribers 180a, 180b, 180c, . . . , 180n (generally 180) of the second IMS network 150. The P-CSCF 165 of the IEN-2 155 and the I-CSCF 175, the S-CSCF 170 and the operator 177 of the ICN-2 160 operate similarly as described above with respect to the first IMS network 110.

During normal operation of the first IMS network 110, the subscribers 145 are served by the first IMS network 110. In the event that the ICN-1 120 shuts down due to an unplanned occurrence (e.g., a natural disaster, an operator shut down, a network malfunction) the first IMS network 110 is designed to allow service availability to it's subscribers 145. Service for subscribers 145 is maintained by migrating the subscribers 145 to the ICN-2 160.

Typically, the second IMS network 150 is geographically located at a site that is different from the geographic location of the first IMS network 110. For example, the first IMS network 110 can be located in Boston, Ma. and the second IMS network 150 can be located in Manhattan, N.Y. Assigning the second IMS network 150 to a site that is geographically remote from the first IMS network 110 ensures that, for example, a natural disaster that shuts down the first IMS network 110 does not impact the second IMS network 150, thus providing service availability to the subscribers 145 of the first IMS network 110.

Generally, once the first IMS network 110 is restored, the subscribers 145 of the first IMS network 110 migrate back to the first IMS network 110. The migration from the second IMS network 150 to the first IMS network 110 is based on the identifier. In some embodiments, the operator 177 controls the migration from the second IMS network 150 to the first IMS network 110 by initiating the migration, specifying a time for migration to start, a duration for migration to occur within, and/or a geographic location for which to migrate.

In some embodiments, the operator 137 indicates to the second IMS network that the first IMS network is restored. Migration of the subscribers 145 to the second IMS network 150 is often referred to “Failover” and migration of the subscribers 145 back to the first IMS network 110 is known as “Fallback.” Some standard Failover procedures are defined in the 3rd Generation Partnership Project Telecommunication Specifications (3GPP TS 23.820). No similar standardized procedures exist for Fallback. During Fallback it is desirable to control migration such that the IMS networks are used efficiently, and to ensure proper traffic planning on the IMS networks.

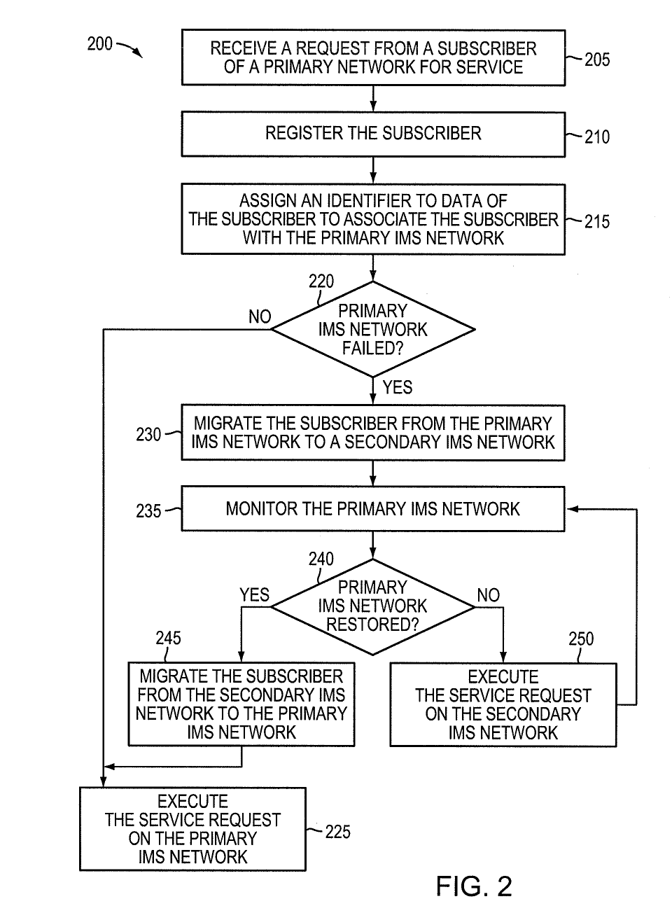

FIG. 2 is a flow chart 200 illustrating a method for disaster recovery in IMS networks, according to an illustrative embodiment of the invention. The method includes receiving a request for service from a subscriber of a primary IMS network (e.g., ICN-1 120 as discussed above in FIG. 1) (Step 205). The service request is received by a P-CSCF (e.g., P-CSCF 125 as discussed above in FIG. 1) associated with the primary IMS network. In various embodiments, the subscriber uses a cell phone device, a PSTN device, an IP telephone device, or a personal computer device to place a call.

The method also includes registering the subscriber on the primary IMS network (Step 210). The method also includes assigning an identifier to data of the subscriber to associate the subscriber with the primary IMS network (Step 215). In one embodiment, the P-CSCF associated with the primary IMS network assigns the identifier. In one embodiment, the identifier is assigned by populating tgrp fields and trunk-context fields that exists in an IP trunk group contact header as part of the RFC 4904 standard. For example, an IP trunk contact header without an identifier (e.g., not populating tgrp and trunk-context) is shown in Table 1.

TABLE 1
Contact: <sip:+918025552000@gateway1.example.com;user=phone>

where sip is a RFC 4904 field that is populated with a uniform resource identifier (URI) (e.g., +918025552000@gateway1.example.com) and user is a RFC 4904 field that is populated with the service request's device type (e.g. phone). The URI identifies an internet resource and location for the requested service. A IP trunk contact header with an identifier (e.g., populating tgrp and trunk-context) is shown in Table 2.

TABLE 2
Contact: <sip:+918025552000;tgrp=TG-A;trunk-
context=example.com@gateway1.example.com;user=phone>

where tgrp is a RFC 4904 field that identifies a trunk group (e.g., TG-A) for the service request and trunk-context is a RFC 4904 field that establishes a scope of the trunk group. In some embodiments, the trunk-context is populated with a sub-domain (e.g., example.com@gateway1.example.com) identifying the trunk group's scope is a subset of gateways. In some embodiments, the trunk-context is populated with a host (e.g., example.com) identifying the trunk group's scope is a specific host. In some embodiments, the trunk-context is populated with a service provider domain (e.g., serviceprovider.com) identifying the trunk group's scope is all gateways in a service provider's domain. In some embodiments, the trunk-context is a global number (e.g., +1-630@isp.example.net) identifying the trunk group's scope is an internet service provider.

In one embodiment, the identifier is a new field that is added to a SIP path header that is part of a RFC 3261 standard. For example, a SIP path header without the identifier (e.g., no new field) is shown in Table 3.

TABLE 3
Path: <sip:gateway1.example.com;lr>

where sip is a RFC 3261 field that is populated with a URI (e.g., gateway1.example.com) and 1r is RFC 3261 field that is a loose-routing indicator parameter. A SIP path header with an identifier field (e.g. new field) is shown in Table 4.

TABLE 4
Path: <sip:gateway1.example.com;x-primary-site=ICN-1;lr>

where x-primary site is a new field (not part of RFC 3261) that is populated with the primary IMS network (e.g., ICN-1). Because the x-primary-site field is not part of the RFC 3261 standard, the identifier is not limited to a field named x-primary-site. The identifier field can be named anything so long as it specifies to an IMS network a particular IMS network to which the subscribers associated with the service requests subscribe. In some embodiments, the identifier x-primary-site includes type of service information, geographic location information, or any combination thereof.

The method also includes detecting failure of the primary IMS network (Step 220). If the primary IMS network is operational the service request is executed using the primary IMS network (Step 225). Otherwise, the subscriber is migrated from the primary IMS network to a secondary IMS network (e.g., secondary IMS network 150 as discussed above in FIG. 1) (Step 230). Generally, the P-CSCF associated with the primary IMS network migrates the subscribers to the I-CSCF of the secondary IMS network.

The method also includes monitoring the primary IMS network (Step 235). The monitoring occurs by transmitting a monitoring message to the primary IMS network. For example, the P-CSCF associated with the primary IMS network can transmit messages to the I-CSCF of the primary IMS network to determine the ICN-1 has been restored. In one embodiment, the secondary IMS network monitors the primary IMS network by transmitting a message to the primary IMS network to determine if the primary IMS network has regained operation. In various embodiments, the message is transmitted at frequencies on the order of deciseconds

If a response to the monitoring message is not returned from the primary IMS network then the secondary IMS network determines the primary IMS network is not restored (Step 240), the service request is executed on the secondary IMS network (Step 250) and the monitoring of the primary IMS network continues (Step 235). In one embodiment, the P-CSCF associated with the primary IMS network determines the primary IMS network is not restored.

If a response to the message is returned from the primary IMS network, the secondary IMS network determines that the primary IMS network is restored (Step 240). The secondary IMS network migrates the subscribers of the primary IMS network from the secondary IMS network to the primary IMS network (Step 245) and the primary IMS network executes the service request (Step 225). The migration from the secondary IMS network to the primary IMS network is based on the identifier assigned above in Step 215.

The identifier enables the secondary IMS network (e.g., S-CSCF 170 of ICN-2 160 as discussed above in FIG. 1) and an operator (e.g., operator 177 as discussed above in FIG. 1) to distinguish between subscribers of the secondary IMS network and subscribers of the primary IMS network such that only subscribers of the primary IMS network are migrated to the primary IMS network. In some embodiments, the subscribers are migrated from the secondary IMS network to the primary IMS network in an order of priority that is based on segmenting the subscribers of the primary IMS network into groups. In some embodiments, the groups are based on the identifier. In some embodiments, the groups are based on a type of service a subscriber subscribes too. For example, the subscriber can subscribe to a regular service plan or an enhanced service plan. The subscribers of the primary IMS network that subscribe to the enhanced service plan can be migrated before the subscribers of the primary IMS network of the regular service plan.

In some embodiments, the S-CSCF of the ICN-2 initiates migration of the subscribers from the secondary IMS network to the primary IMS network. In some embodiments, an operator initiates the migration of the subscribers from the secondary IMS network to the primary IMS network. In some embodiments, the S-CSCF of the ICN-2 specifies the groups and the priority for migration. In some embodiments, the operator specifies the groups and the priority for migration. In some embodiments, the operator specifies a geographic location of the primary IMS network. In some embodiments, the S-CSCF of the ICN-2 specifies a time for the migration to begin. In some embodiments, the operator specifies a time for the migration to begin. In some embodiments, the S-CSCF of the ICN-2 specifies a duration for the migration to occur, such that traffic on the secondary IMS network is controlled. In some embodiments, the S-CSCF of ICN-2 specifies the rate at which the subscribers are preferred to be migrated, so that traffic on the secondary IMS network is controlled. In some embodiments, the operator specifies the rate at which the subscribers are preferred to be migrated, so that traffic on the secondary IMS network is controlled.

In some embodiments, the migration of the subscribers from the secondary IMS network to the primary IMS network is prioritized by an amount of traffic on the secondary IMS network and/or the primary IMS network.

In some embodiments, the primary IMS network and the secondary IMS network each include one I-CSCF and one S-CSCF. In some embodiments, the primary IMS network and the secondary IMS network each include multiple I-CSCF and multiple S-CSCF. In some embodiments, where the primary IMS network includes multiple I-CSCF, a P-CSCF associated with the primary IMS network chooses the I-CSCF that the subscribers migrate to.

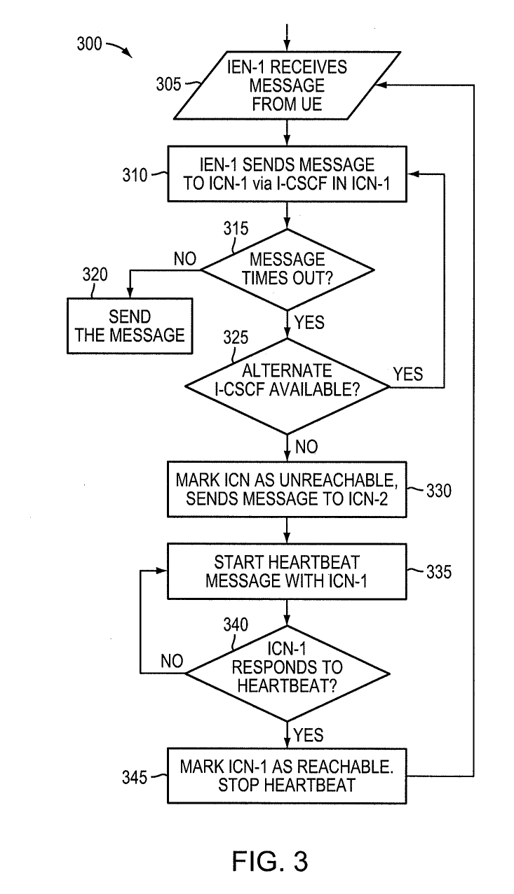

FIG. 3 is a flow chart 300 illustrating a method for determining a state of a primary IMS network, according to an illustrative embodiment of the invention. The method includes receiving by IEN-1 (e.g., IEN-1 115 as described above in connection with FIG. 1) a message from a unit of user equipment (UE) (e.g. cell phone) (Step 305). In some embodiments, services include call and non-call related services including requests for services of a call session, caller ID, call waiting, call holding, push to talk, call forwarding, call transfer, call blocking, malicious caller identification, lawful interception, announcement services, conference call services, voicemail, text to speech and speech to text, location-based services, messaging services and instant messaging, presence information, enumeration (ENUM), and 2-G gateway services.

The method also includes transmitting a message from IEN-1 to ICN-1 (e.g., ICN-1 120 as described above in connection with FIG. 1) via an I-CSCF of ICN-1 (Step 310). The method also includes determining, by the IEN-1, if the message times out (Step 315). If the message does not time out, then the message is sent to I-CSCF of ICN-1 (Step 320). If the message does time out, then IEN-1 determines if an alternate I-CSCF of ICN-1 is available (Step 325). If the alternate I-CSCF is available then the method loops back to Step 310 and the message is sent to the alternate I-CSCF (Step 310). If an alternate I-CSCF is not available, then ICN-1 is unavailable and the message is sent to I-CSCF of ICN-2 (Step 330).

The method also includes sending a heartbeat message from IEN-1 to I-CSCF of ICN-1 (Step 335). The heartbeat message is a message sent at a frequency. The IEN-1 determines if I-CSCF of ICN-1 responds to the heartbeat message (Step 340). If I-CSCF of ICN-1 does not respond the to message then another heartbeat message is sent to I-CSCF of ICN-1 (Step 335). If I-CSCF of ICN-1 does respond to the heartbeat message, then IEN-1 stops sending the heartbeat message (Step 345) and a next service request message is sent to I-CSCF of ICN-1.

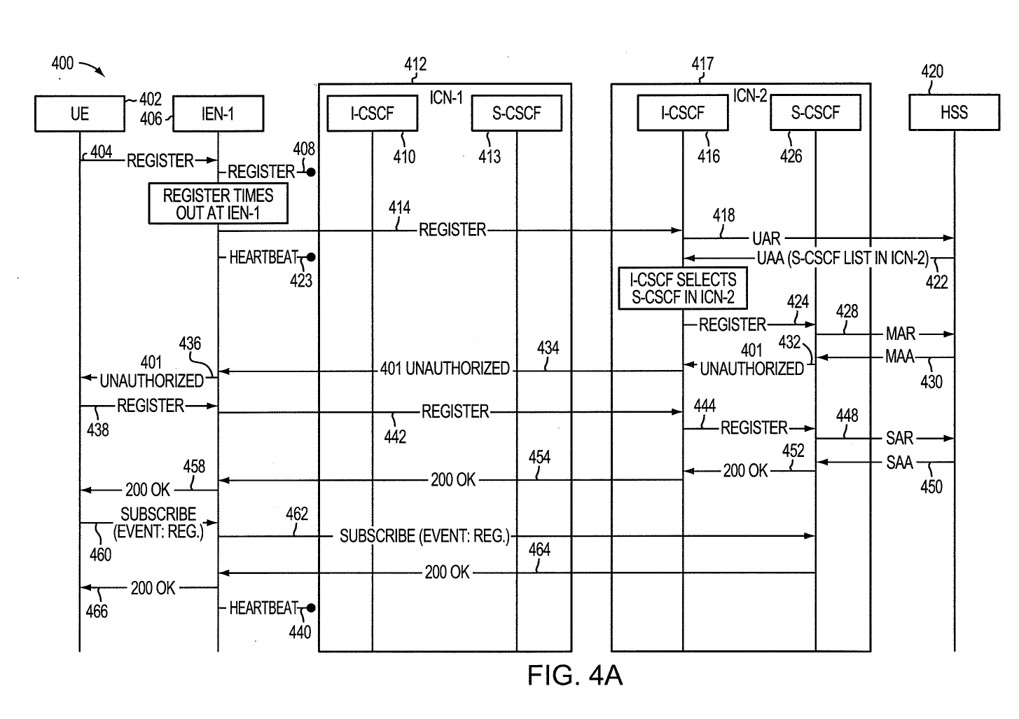

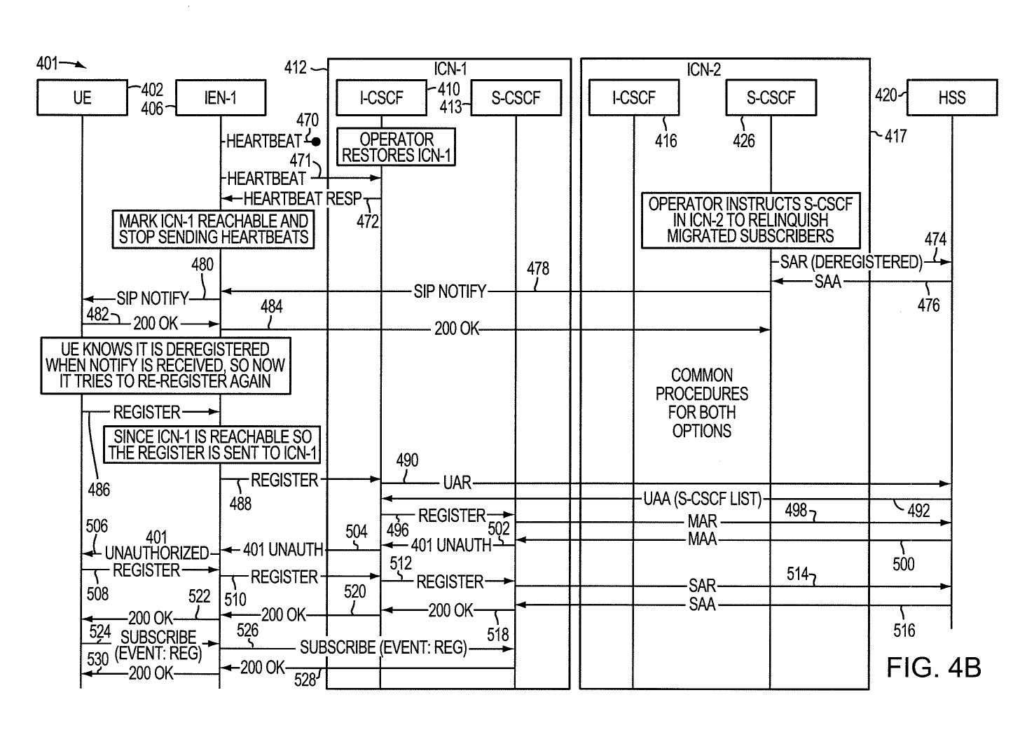

FIG. 4A is a sequence diagram 400 for migrating a subscriber from a primary IMS network to a secondary IMS network with SIP protocol and Diameter protocol messaging, according to an illustrative embodiment of the invention. The user equipment (UE) 402 sends a REGISTER message 404 to the IEN-1 406 requesting service. The IEN-1 406 attempts to send a REGISTER message 408 to a I-CSCF 410 of ICN-1 412. The REGISTER message 408 could not be delivered to the I-CSCF 410 and a local time out occurs at the IEN-1 406. The IEN-1 406 sends a REGISTER message 414 to a I-CSCF 416 of ICN-2 417. The I-CSCF 416 sends a User Authorization Request (UAR) message 418 to the HSS 420 to determine if the UE 402 is allowed to receive service, and if so, requests the address of a local SIP server capable of handling a user associated with the UE 402.

The HSS 420 sends a User-Authorization-Answer (UAA) message 422 to the I-CSCF 416 indicating a list of capabilities that the I-CSCF 416 can use in selecting the appropriate S-CSCF to send the request to. The I-CSCF 416 selects S-CSCF 426 in ICN-2 417. The I-CSCF 416 sends a REGISTER request 424 to the S-CSCF 426. The S-CSCF 426 sends a Multimedia-Authorization-Request (MAR) message 428 to the HSS 420. The HSS 420 sends a Multimedia-Authorization-Answer (MAA) message 430 to the S-CSCF 426 indicating authentication of the UE 402 is needed. In parallel with sending the UAA message 422, the IEN-1 transmits a heartbeat message 423 to the I-CSCF 410 to determine if ICN-1 is operational.

The S-CSCF 426 sends a 401 Unauthorized message 432 to the I-CSCF 416. The I-CSCF 416 sends a 401 Unauthorized message 434 to the IEN-1 406. The IEN-1 406 sends a 401 Unauthorized message 436 to the UE 402. The UE 402 responds by sending a REGISTER message 438 that contains the UE's credentials to the IEN-1 406. The IEN-1 406 sends a REGISTER message 442 that contains the UE's credentials to the I-CSCF 416. The I-CSCF 416 sends a REGISTER message 444 that contains the UE's credentials to the S-CSCF 426. The S-CSCF 426 sends a Server-Assignment-Request (SAR) message 448 to the HSS 420 requesting completion of authentication and user profile information for a subscriber associated with the UE 402. The HSS 420 sends a Server-Assignment-Answer (SAA) message 450 to the S-CSCF 426 that contains the requested user profile information. In parallel with sending the REGISTER message 442, the IEN-1 406 transmits a heartbeat message 440 to the I-CSCF 410 to determine if ICN-1 412 is operational.

The S-CSCF 426 sends a 200 OK message 452 to the I-CSCF 416 indicating acceptance of the UE request. The I-CSCF 416 sends a 200 OK message 454 to the IEN-1 406 indicating acceptance of the UE request. The IEN-1 sends a 200 ok message 458 to the UE 402 indicating acceptance of the UE request. The UE 402 sends a SUBSCRIBE message 460 to the IEN-1 406. The IEN-1 sends a SUBSCRIBE message 462 to the S-CSCF 426 requesting information about the status of the subscriber's registration. The S-CSCF 426 sends a 200 ok message 464 to the IEN-1 406 indicating that the subscriber's registration status is active. The IEN-1 406 sends a 200 OK message 466 to the UE 402 indicating that the services session's status is active. The IEN-1 406 sends a heartbeat 468 to I-CSCF 410 to determine if ICN-1 412 is operational.

The IEN-1 406 continues to send heartbeat messages to the I-CSCF 410 until ICN-1 412 is restored.

In some embodiments, the I-CSCF 416 selects a S-CSCF from a group of S-CSCFS associated with ICN-2 417.

FIG. 4B is a sequence diagram 401 for migrating the subscriber of FIG. 4A from the secondary IMS network to the primary IMS network with SIP protocol and Diameter protocol messaging. The IEN-1 406 sends heartbeat message 470 to the I-CSCF 410 to determine if ICN-1 is operational. An operator (not shown) restores service to I-CSCF 410. The IEN-1 sends heartbeat message 471 to I-CSCF 410 to determine if ICN-1 is operational. The I-CSCF 410 sends a heartbeat response message 472 to IEN-1 406. The IEN-1 406 indicates that ICN-1 412 is now reachable and relinquishes sending heartbeat messages to I-CSCF 410.

An operator of ICN-2 417 learns that ICN-1 412 is operational and instructs S-CSCF 426 to migrate the UE's session back to ICN-1 412. The operator identifies the appropriate UE's session to migrate based on an identifier as discussed above in connection with FIG. 3. The S-CSCF 426 sends a SAR message 474 to the HSS 420 that deregisters the UE 402. The HSS 420 sends a SAA message 476 to the S-CSCF 426. The S-CSCF 426 sends a SIP NOTIFY message 478 to the IEN-1 406 indicating the UE 402 is deregistered from S-CSCF 426. The IEN-1 406 sends a SIP NOTIFY message 480 to the UE 402 indicating the UE 402 is deregistered from S-CSCF 426.

The UE 402 sends a 200 OK message 482 to the IEN-1 406 acknowledging deregistration. The IEN-1 406 sends a 200 OK message 484 to S-CSCF 426 acknowledging deregistration of the UE 402.

The user equipment (UE) 402 sends a REGISTER message 486 to the IEN-1 406 to request service. The IEN-1 406 sends a REGISTER message 488 to the I-CSCF 410 of ICN-1 412. Since ICN-1 412 is now operational, the I-CSCF 410 sends a UAR message 490 to the HSS 420 to determine if the UE 402 is allowed to receive service, and if so, requests the address of a local SIP server capable of handling a user associate with the UE 402.

The HSS 420 sends a UAA message 492 to the I-CSCF 410 indicating a list of capabilities that the I-CSCF 410 can use in selecting the appropriate S-CSCF to send the request to. The I-CSCF 410 selects S-CSCF 413 in ICN-1 412. The I-CSCF 410 sends a REGISTER request 496 to the S-CSCF 413. The S-CSCF 413 sends a MAR message 498 to the HSS 420. The HSS 420 sends a MAA message 500 to the S-CSCF 413 indicating authentication of the UE 402 is needed.

The S-CSCF 413 sends a 401 Unauthorized message 502 to the I-CSCF 410. The I-CSCF 410 sends a 401 Unauthorized message 504 to the IEN-1 406. The IEN-1 406 sends a 401 Unauthorized message 506 to the UE 402. The UE 402 responds by sending a REGISTER message 508 that contains the UE's credentials to the IEN-1 406. The IEN-1 406 sends a REGISTER message 510 that contains the UE's credentials to the I-CSCF 410. The I-CSCF 410 sends a REGISTER message 512 that contains the UE's credentials to the S-CSCF 413. The S-CSCF 413 sends a SAR message 514 to the HSS 420 requesting completion of authentication and user profile information for the subscriber associated with the UE 402. The HSS 420 sends a SAA message 516 to the S-CSCF 413 that contains the requested user profile information.

The S-CSCF 413 sends a 200 OK message 518 to the I-CSCF 410 indicating acceptance of the UE request. The I-CSCF 410 sends a 200 OK response 520 to the IEN-1 406 indicating acceptance of the UE request. The IEN-1 sends a 200 ok message 522 to the UE 402 indicating acceptance of the UE request. The UE 402 sends a SUBSCRIBE message 524 to the IEN-1 406. The IEN-1 sends a SUBSCRIBE message 526 to the S-CSCF 413 requesting information about the status of the subscriber's registration. The S-CSCF 413 sends a 200 ok message 528 to the IEN-1 406 indicating that the subscriber's registration status is active. The IEN-1 406 sends a 200 OK message 530 to the UE 402 indicating that the subscriber's session status is active.

In various embodiments, the disclosed methods may be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems.

Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

The described embodiments of the invention are intended to be merely exemplary and numerous variations and modifications will be apparent to those skilled in the art. All such variations and modifications are intended to be within the scope of the present invention as defined in any appended claims.

1. A method of maintaining service availability for an Internet Protocol Multimedia Subsystem (IMS) network, comprising:
registering, a primary network, one or more subscribers;
receiving a request, by the primary network, from the one or more subscribers of the primary network, to initiate a service;
assigning, by the primary network, an identifier to data of the one or more registered subscribers for the registration wherein the identifier associates the one or more subscribers with the primary network upon migration of the one or more subscribers from the primary network to a secondary network;
monitoring, by the secondary network, the primary network to detect an event on the primary network; and
migrating the one or more subscribers from the secondary network to the primary network based on the identifier and after initiation of the migration in response to the occurrence of the event on the primary network.

2. The method of claim 1, wherein migrating the one or more subscribers from the secondary network to the primary network is further in response to an operator command.

3. The method of claim 2, wherein migrating in response to the operator command comprises:
specifying a geographic location of the primary network to which the one or more subscribers migrate;
specifying a time for the one or more subscribers to begin migrating; and
specifying a rate at which the one or more subscribers are preferred to be migrated.

4. The method of claim 3, wherein migrating in response to the operator command comprises:
specifying one or more subset groups of the one or more subscribers; and
migrating the one or more subset groups based on an order of priority.

5. The method of claim 1, comprising visually displaying a migration status showing the migration state of the migration of the one or more subscribers between the primary network and the secondary network to an operator.

6. The method of claim 1, wherein the identifier is based on the one or more subscribers' type of service, a geographic location of the one or more subscribers, or any combination thereof.

7. The method of claim 6, wherein the one or more subscribers is a plurality of subscribers and migrating the plurality of subscribers from the secondary network to the primary network is further based on an order of priority among each of the plurality of subscribers.

8. The method of claim 7, wherein the order of priority is based on at least one of traffic level on the secondary network, the one or more subscribers type of service, or an operator command.

9. The method of claim 1, wherein assigning the identifier further comprises adding the identifier to one or more IP trunks associated with the one or more subscribers.

10. The method of claim 9, wherein assigning the identifier further comprises inserting at least one of a group parameter or a context parameter in a header of each of the one or more IP trunks.

11. The method of claim 1, wherein assigning the identifier further comprises augmenting a path header associated with the primary network.

12. The method of claim 11, wherein the path header further comprises a SIP path header.

13. The method of claim 11, wherein augmenting the path header further comprises inserting a parameter into the path header.

14. The method of claim 1, wherein monitoring the primary network further comprises:
sending traffic signals to the primary network from the secondary network at a fixed time interval; and
detecting a response signal from the primary network.

15. The method of claim 14, wherein detecting a response signal further comprises transmitting the response signal to the secondary network.

16. The method of claim 1, wherein the primary network comprises a first interrogating network and a first session handling server.

17. The method of claim 16, wherein receiving the request further comprises:
transmitting the request, by an entry point network associated with the primary network, to the first interrogating network associated with the primary network;
obtaining subscriber data, by the first interrogating network, from a subscriber server based on the request and the one or more subscribers; and
routing, by the first interrogating network, the request to the first session handling server, wherein the first session handling server initiates sessions for each of the one or more subscribers and handles services for each of the one or more subscribers.

18. The method of claim 17, wherein the secondary network comprises a second interrogating network and a second session handling server.

19. The method of claim 18, further comprising migrating the one or more subscribers from the primary network to the secondary network.

20. The method of claim 18, wherein migrating the one or more subscribers further comprises:
transmitting the request and the subscriber data from the entry point network to the second interrogating network associated with the secondary network; and
routing, by the second interrogating network, the request to the second session handling server, wherein the second session handling server initiates sessions for each of the one or more subscribers and handles services for each of the one or more subscribers.

21. The method of claim 16, wherein assigning the identifier further comprises:
inserting at least one of a context parameter or a group parameter in at least one header of one or more IP trunks associated with the one or more subscribers, wherein the context parameter indicates the primary network that transmitted the request and the group parameter indicates the one or more IP trunks and the one or more subscribers type of service.

22. The method of claim 16, wherein assigning the identifier further comprises
inserting a context parameter into a path header associated with the one or more subscribers, wherein the context parameter indicates the primary network.

23. The method of claim 19, wherein the migrating the one or more subscribers from the secondary network to the primary network further comprises terminating the sessions and the services initiated by the second session handling server once the migration is complete.

24. A computer program product for maintaining service availability on an Internet Protocol Multimedia Subsystem (IMS) network, tangibly embodied in a computer-readable storage medium, the computer program product containing instructions being operable to cause a data processing apparatus to:
register, by a primary network, one or more subscribers;
receive a request, by the primary network, from the one or more subscribers of the primary network, to initiate a service;
assign, by the primary network, an identifier to data of the one or more registered subscribers for the registration;
monitor, by a secondary network, the primary network to detect an event on the primary network; and
migrate the one or more subscribers from the secondary network to the primary network based on the identifier and after initiation of the migration in response to the occurrence of the event on the primary network.

25. A system for maintaining service availability for an Internet Protocol Multimedia Subsystem (IMS) network, comprising:
means for registering, by a primary network, one or more subscribers;
means for receiving a request, by the primary network, from the one or more subscribers of the primary network, to initiate a service;
means for assigning, by the primary network, an identifier to data of the one or more registered subscribers for the registration;
means for monitoring, by a secondary network, the primary network to detect an event on the primary network; and
means for migrating the one or more subscribers from the secondary network to the primary network based on the identifier and after initiation of the migration in response to the occurrence of the event on the primary network.

26. A method of maintaining service availability for an Internet Protocol Multimedia Subsystem (IMS) network, comprising:
monitoring, by a secondary network, a primary network to detect an event on the primary network; and
migrating one or more subscribers from the secondary network to the primary network based on an identifier assigned to the one or more subscribers and after initiation of the migration in response to the occurrence of the event on the primary network,
wherein the one or more subscribers were initially registered on the primary network and wherein the identifier assigned to the one or more subscribers associated the one or more subscribers with the primary network when initially migrated from the primary network to the secondary network.
